(19) United States
(12) Patent Application Publication
(10) Pub. No.: US 2015/0220704 A1
(43) Pub. Date: Aug. 6, 2015

(54) Clinical Decision Support System over a bipartite graph

(71) Applicant: International Business Machines Corporation, Armonk, NY (US)

(72) Inventors: Boaz Carmeli, Koranit (IL); ARIEL FARKASH, Shimshit (IL); ESTHER GOLDBRAICH, Haifa (IL); KSENYA KVELER, Yoqneam Illit (IL); YEVGENIA TSIMERMAN, Haifa (IL); ZEEV WAKS, Petach Tikva (IL)

(73) Assignee: International Business Machines Corporation, Armonk, NY (US)

(21) Appl. No.: 14/172,937

(22) Filed: Feb. 5, 2014

(51) Int. Cl. G06F 19/00; G06F 3/0484; G06F 3/0482

(52) U.S. Cl. CPC G06F 19/3481; G06F 3/0482; G06F 3/0484

(57) ABSTRACT

Machines, systems and methods for supporting clinical decisions comprises providing a graphical user interface (GUI) to facilitate selection of one or more treatment plans (TPs) for one or more clinical presentations (CPs), wherein data records for the TPs and the CPs are implemented over a data structure that defines one or more relationship between the CPs and the TPs, according to medical guidelines or clinical data, wherein interaction with the GUI allows for filtering through TPs associated with one or more CPs, or filtering through CPs associated with one or more TPs, wherein selecting a CP from among a plurality of the CPs results in display of one or more TPs associated with the selected CP, and wherein cross-referencing between results displayed in response to the selection of the selected CP and TP provides details that help determine one or more relevant TPs for a target CP.

### COPYRIGHT & TRADEMARK NOTICES

A portion of the disclosure of this patent document may contain material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to clinical decision support systems and, more particularly, to a system and method for providing a user with information about possible treatments available for one or more clinical presentations.

### BACKGROUND

Clinical decision support systems help a healthcare provider or physician diagnose an illness and possibly determine the most suitable treatment for a patient. The current systems allow the user to provide as input one or more symptoms and as output receive one or more possible diagnosis or related treatments.

As such, the input to the system may include one or more symptoms, for example “runny nose”. And, the output may be a diagnosis for that symptom such as “viral cold”, “bacterial cold”, or “sinus allergy”. Some systems may also recommend one or more treatments, depending on the diagnosis, such as a prescription for “pain reliever”, “antibiotics”, or “antihistamine”, for example.

Current systems achieve certain objectives to simplify or educate the user about the possible diagnosis or treatments, with a limited level of information that is provided to the user in a manner that is typically not very intuitive or easy to follow or appreciate. It is desirable to have a solution that combines physician insights with known guidelines and best practices in a simple and intuitive manner.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with one embodiment, a method for supporting clinical decisions comprises providing a graphical user interface (GUI) to facilitate selection of one or more treatment plans (TPs) for one or more clinical presentations (CPs), wherein data records for the TPs and the CPs are implemented over a data structure that defines one or more relationship between the CPs and the TPs, according to medical guidelines or clinical data, wherein interaction with the GUI allows for filtering through TPs associated with one or more CPs, or filtering through CPs associated with one or more TPs, wherein selecting a CP from among a plurality of the CPs results in display of one or more TPs associated with the selected CP, and wherein cross-referencing between results displayed in response to the selection of the selected CP and TP provides details that help determine one or more relevant TPs for a target CP, whether or not the relevant TPs have been recommended under the medical guidelines.

In accordance with one or more embodiments, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1A illustrates an exemplary data structure in which the nodes represent clinical presentations (CPs) or treatment plans (TPs), and the edges that define relationships between the CPs and the TPs, in accordance with one or more embodiments.

FIG. 1B is an exemplary diagram of sample graphical icons utilized to represent different relationships between the CPs and the TPs, in accordance with one or more embodiments.

FIG. 2 is an example diagram of a CP chart and a TP chart that graphically illustrate the relationships defined in the chart on top of FIG. 2, in accordance with one embodiment.

FIGS. 3 through 6 are illustrations of an exemplary graphical user interface that facilitates the selection of a TP for a CP, in accordance with one embodiment.

FIG. 7 is an exemplary diagram of sample graphical icons utilized to represent different options to expand or narrow candidate CPs and the TPs, in accordance with one or more embodiments.

FIGS. 8 and 9 illustrates an exemplary TP and CP nodes with edges defining relationships between the CPs and the TPs when the candidate nodes are narrowed or expanded, in accordance with one or more embodiments.

FIGS. 10A and 10B are block diagrams of hardware and software environments in which the disclosed systems and methods may operate, in accordance with one or more embodiments.

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

In accordance with one or more embodiments, a system is implemented to provide a user (e.g., a physician or a healthcare provider) with a tool or decision system that would allow the user to desirable interact with a graphical user interface (GUI) to traverse back and forth between one or more clinical presentations (CP) and one or more possible treatment programs (TP) that have been suggested, approved, utilized or recognized as suitable for treating the one or more CPs, either experimentally or otherwise. As such, the system may include a list of CPs and a list of TPs.

An example of a CP is “localized Leiomyosarcoma in the limb or trunk surface, superficial, high grade, larger than 5 cm tumor”. An example of a TP is “Surgery (Wide Excision), pre and/or post-operative Radiotherapy”. A CP may include a list of clinical features (CFs) (e.g., “deep tumor”, “large tumor” or “high grade tumor”). For example, the CP “localized Leiomyosarcoma in the limb or trunk surface, superficial, high grade, larger than 5 cm tumor” may include the features: (i) localized Leiomyosarcoma, (ii) limb or trunk surface, (iii) superficial, (iv) high grade, and (v) larger than 5 cm tumor. A TP may include a list of treatment features (TFs) “Wide excision” or “Radiotherapy”. For example the TP “Surgery (Wide Excision), pre and/or post-operative Radiotherapy” may include the treatment features (i) wide excision and (ii) radiotherapy.

The decision system may be provided with a GUI that may be designed so that the user may enter certain keywords or interact with a menu (e.g., a dropdown list of CFs, CPs, TFs or TPs) to provide information about one or more CPs, TPs or a combination thereof. In return, the user may be provided with one or more (desirably two) interactive charts (e.g., a CP chart and a TP chart) and a set of visual indications related to the association between a list of CP-TP pair. As provided in further detail below, a CP chart may graphically display a list of CPs for some type of diseases (e.g., breast cancer). The possible CPs for a given clinical feature (CF) such as local or metastatic disease may be presented as local type 1, local type 2, metastasized type 1, metastasized type 2, etc. A TP chart may graphically display a list of TPs for some type of disease (e.g., breast cancer). The possible TPs for a given treatment feature (TF) such surgery or chemo may be Surgery type 1, Surgery type 2, Chemotherapy type 1, Chemotherapy type 2, etc.

Accordingly, the one or more TPs in the TP chart may be representations of possible treatments for the one or more CPs in the CP chart. The determination about the relationship between the CPs and TPs (i.e., which CPs are treated by which TPs) may be based on clinical practice guidelines or collected patient data as stored in a database and organized by way of computing data structures. One or more data structures (e.g., a bipartite graph) may be implemented to maintain the relationships or associations between the TPs and the possible CPs and vice versa. As such, information and records in the respective databases or data structures may be used to populate the CP and the TP charts.

It is noteworthy that, depending on implementation, the relationships or associations between a TP and a CP may be defined in different manners. For example, a TP may be marked as the proper treatment for a CP according to certain guidelines. Or, a TP may be marked as a deviation (e.g., an experimental treatment) for a CP based on an analysis of patient records or certain studies, for example. In one implementation, a deviant TP may be deemed relevant to the CP even if it is not recommended by the guidelines, as provided in further detail below.

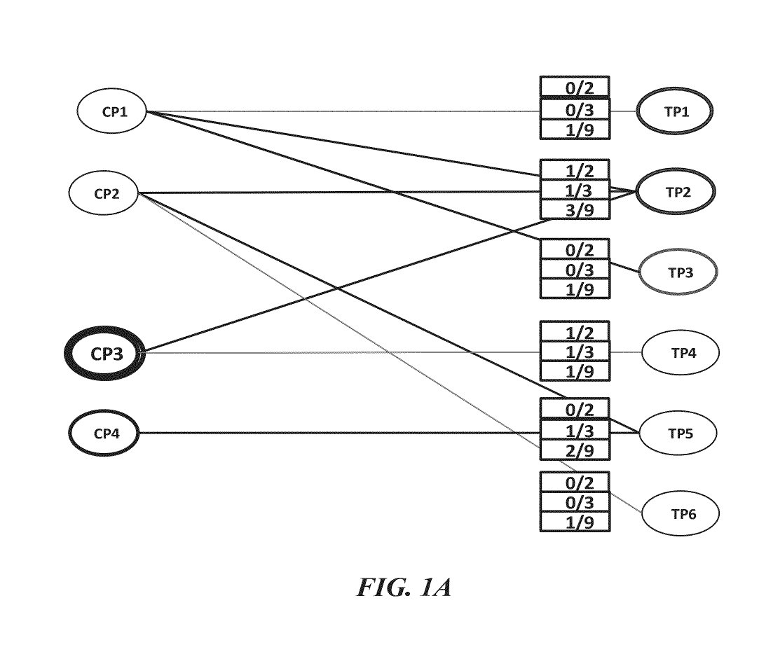

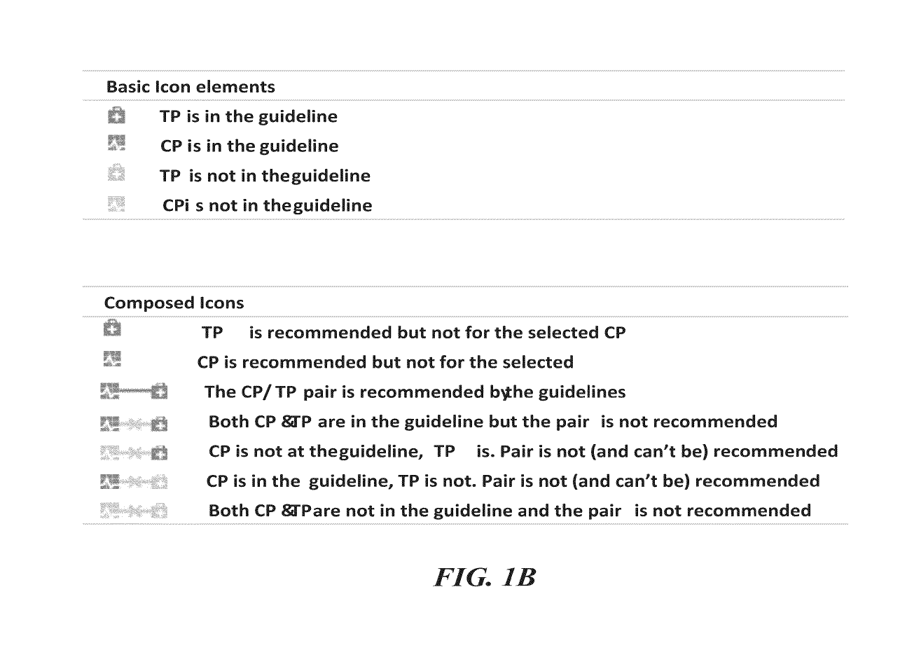

FIG. 1A illustrates a block diagram of an exemplary scenario, where a bipartite graph is used to define the relationships between CPs 1 through 4 (the 4 nodes vertically aligned on the left) with TPs 1 through 6 (the 6 nodes vertically aligned on the right). As reflected by the edges connecting the nodes, TP1, TP2 and TP3 are possible treatments for CP1. TP2, TP5 and TP6 are possible treatments for CP2. TP2 and TP4 are possible treatments for CP3. And, TP5 is a possible treatment for CP4. It is noteworthy that the illustration in FIG. 1A is exemplary in nature and that the relationships between the TPs and the CPs or the type of data structure utilized to maintain such relationships may be implemented by way of alternative means.

In accordance with one embodiment, three different states (e.g., neutral, candidate and selected) may be identified or defined for each TP or CP. In the neutral state, no nodes in the graph are marked. In the candidate state, one or more nodes are marked as candidate nodes. In the selected state, one candidate node is targeted or activated for detailed analysis. Further details about the possible states for a CP or TP, and how each state may be utilized to provide meaningful information about the relationship between a CP and a TP, are provided below in application to a practical example. It should be noted that the provided examples herein are for illustration purposes and to provide a better understanding of the concepts disclosed herein and should not be construed to unduly narrow the scope of the claimed subject matter to any particular details.

Referring back to FIG. 1A, in one example embodiment, one or more edge indicators may be calculated for a node, depending on the possible states associated with a node and the states that are associated with the nodes at the other side of this node's edges. The edge indicator in a certain state may be calculated as the number of incoming edges to a node from the given group out of the number of the outgoing edges from the relevant group. In FIG. 1A, for example, three edge indicators are illustrated for each node on the right. The edge indicators may be also calculated for the nodes on the left side of the graph. As shown, three edge indicators are stacked on top of each other for each node. However, the graphical representation may be in any form (e.g., stacked vertically, stacked horizontally, as a coma delimited list, etc.).

In the example of FIG. 1A, the top edge indicator is calculated based on the selected state of the nodes, the middle edge indicator is calculated based on the candidate state of the nodes, and the bottom edge indicator is calculated based on the neutral state of the nodes in the graph, where CP3 is active, CP4, TP1, TP2, and TP3 are selected, and CP1, CP2, TP4, TP5, and TP6 are in neutral state. For example, for TP1, 0/2 indicates that out of two active edges in the graph going out from CP3, zero edges go into TP1; 0/3 indicates that out of three candidate edges in the graph (2 out of CP2 and 1 out of CP4), zero edges go into TP1; and 1/9 indicates that in the neutral state out of 9 edges going out of all the nodes, only one of the edges goes into TP1.

The visual presentation of the edges and the edge indicators for different states of a node may be helpful to a user to determine whether a recommended TP in a guideline the possible TPs available for one or more CPs and whether alternative TPs are available other than the one or more TPs that are noted in the guidelines. For example, a review of the edge indicators associated with one or more nodes may relay that a certain percentage of the patient population with the same CP got the indicated TP and that the achieved outcome for that population portion was at a certain level. In addition to the above edge indicators, other details such as the number of patients associated with a CP that have been treated according to a TP, the most relevant TP for a CP, the best suited TP for a CP, the available alternative TPs for a CP, etc. may be associated with a node, so that a user may easily review that information.

According, in addition to defining the above-noted relationships and associations between the TP and CP nodes, a more user friendly visual or graphical presentation of a TP or a CP may be provided as implemented in a TP chart or a CP chart. Such visual presentation may be implemented so that it reflects, for example, whether a TP is associated with a CP, whether the TP is defined according to any guidelines, etc., with the idea that the above defined relationships between a CP and a TP may be readily understood by a user simply by looking at such visual presentation. Without limitation, an exemplary graphical presentation for the TPs and CPs according to an exemplary methodology is provided in FIG. 1B.

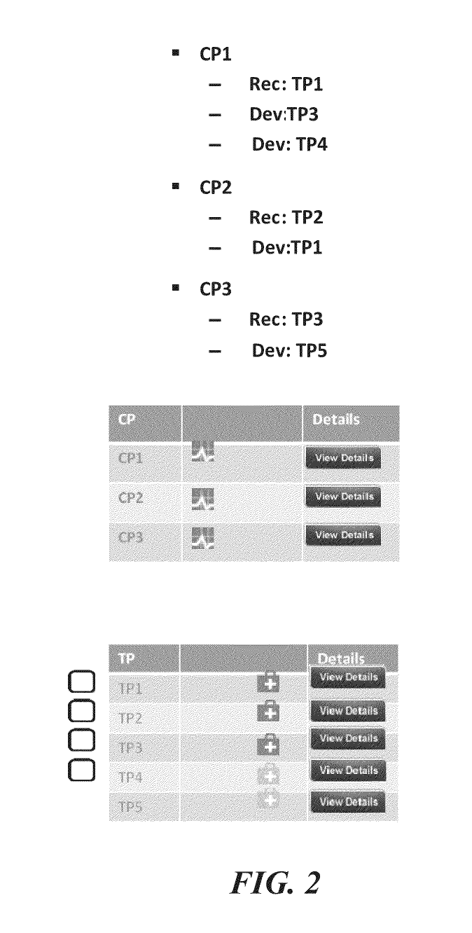

Referring to FIG. 2, after the user has entered information about one or more TPs or CPs to the system, in a first state (e.g., a neutral state), the information presented in the two charts (i.e., the CP chart shown on the top, and the TP chart shown at the bottom) may not designate an association (e.g., may not provide a visual one to one relationship) between a TP and a CP. That is, looking at the two charts in the neutral state, a user may not be able to fully appreciate the relationship between a TP and a CP and would not know which TP is appropriate for a CP. However, looking at the charts in the neutral state would provide the user with an overall understanding that for the CPs that are shown in the CP chart, several TPs are possible and vice versa.

For example, referring to FIG. 2, the user can determine that at least one of the nodes TP1 through TP5 represent possible treatment plans for at least one of CP1 through CP3. However, the more detailed relationships, which are determinable according to the records stored in a database are not viewable in the neutral state. For example, referring to the listing on the top of FIG. 2, the database records may indicate that CP1 has a recommended treatment as TP1, and two deviation treatments TP3 and TP4, where CP1, TP1 and TP3 are in the guidelines, but TP4 is not.

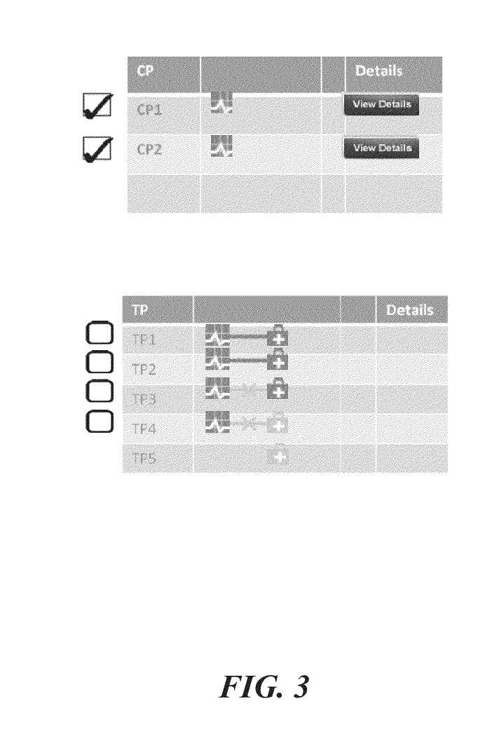

For the user to be able to access the additional details, the user interface may be implemented to allow the user to select one or more CPs and/or one or more TPs from the charts as candidates. In one embodiment, if a CP or TP is selected as a candidate, then the relationship between the corresponding CPs or TPs are visually presented. Referring to FIG. 3, for example, when CP1 and CP2 are selected as candidates in the CP chart, the TP chart is updated to show that TP1 through TP4 are possible treatments for at least one of the two CP1 or CP2.

Referring back to FIG. 1 exemplary legends, in FIG. 3, the listing in the TP chart suggests that TP1 and TP2 may be potentially recommended treatments for either CP1 or CP2 under the guidelines. TP3 may be a potential treatment but not a recommended TP for either CP1 or CP2. Finally, as shown in FIG. 1, TP5 is a TP that is not in the guidelines as a recommendation for either CP1 or CP2. However, note that if CP3 was selected as a candidate, TP5 would have been shown as a potential deviant TP, in accordance with the example scenario illustrated in FIG. 3.

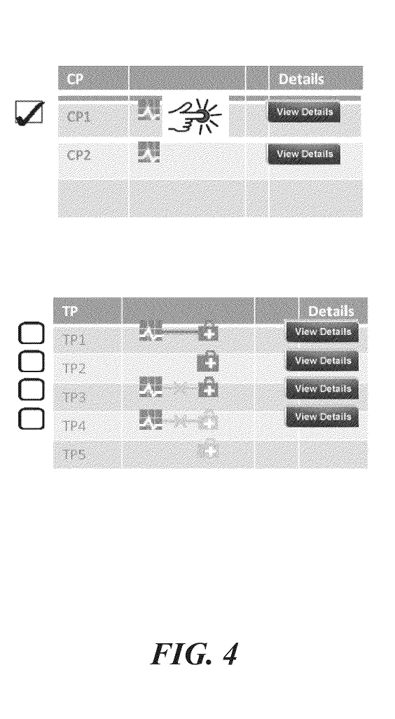

Referring to FIG. 4, a user may further interact with the user interface to affirmatively select and activate a CP, such as CP1. Upon activating CP1 in the CP chart, the TP chart is updated to show additional options (e.g., view details button) and also remove associations between the listed TPs in the TP chart that do not correspond directly with the activated CP. In the example of FIGS. 3 and 4, once CP1 is activated, CP2 is no longer deemed as a candidate and as a result, the TP2 which is a recommended TP for CP2 is no longer shown as a recommended TP in the TP chart. It should be noted however that while TP2 is no longer shown as a recommended TP, it remains as a potential TP. In this manner, a user looking at FIG. 4 would be able to determine that for CP1, the recommended TP is TP1 and that TP3 is a deviation treatment, where both TP1 and TP3 are within the guidelines.

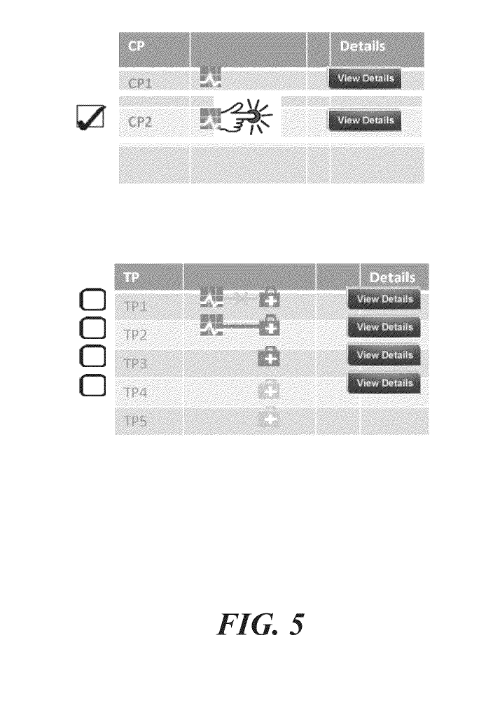

Referring to FIG. 5, if the user would like to understand which treatments are associated with CP2, the user may interact with the user interface to activate CP2 in the CP chart. As shown, the result would indicate that TP2 is the recommended TP for CP2, and that TP1 is a deviated treatment for CP2.

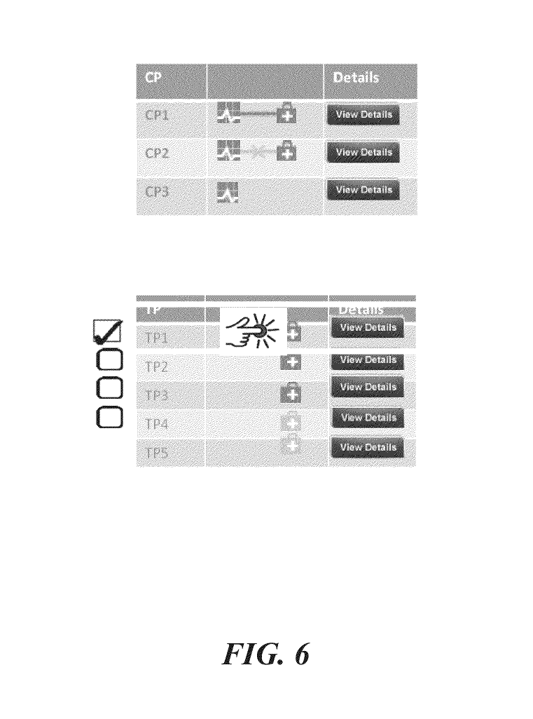

Referring to FIG. 6, in addition or instead of activating CPs in the CP chart, in one implementation, the user may activate at least one TP from the TP chart. Exemplary embodiments thus provide a cross-reference feature that allows a user to select (e.g., as a candidate or as an active selection) back and forth between potential TPs available for one or more CPs, without necessarily having to make a particular diagnosis. In other words, in comparison to the prior systems that require a diagnosis before the available treatment plans can be identified, the claimed subject matter advantageously allows a user to determine and explore different relationships between possible TPs and symptoms that are presented as a part of one or more CPs, without having to make a forced diagnosis first.

For example, as shown in FIG. 6, once a user selects TP1 as an active TP, the CP chart is updated to show that CP1 is a CP that under the guidelines can be treated with TP1, and that TP1 may be also used to treat CP2, even though the guidelines do not recommend it. Depending on implementation, the user may use, in addition to the above feature, other means (e.g. filters, set logic, etc.) to narrow or expand the potential selection of TP and CP pairs. During this narrowing or expansion process, the system may provide the most suitable TP/CP pair within the user's selection set or outside of the selection.

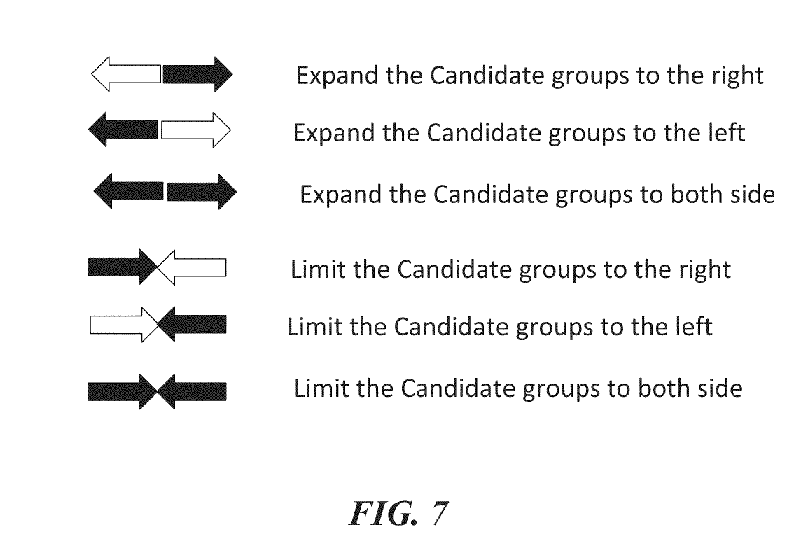

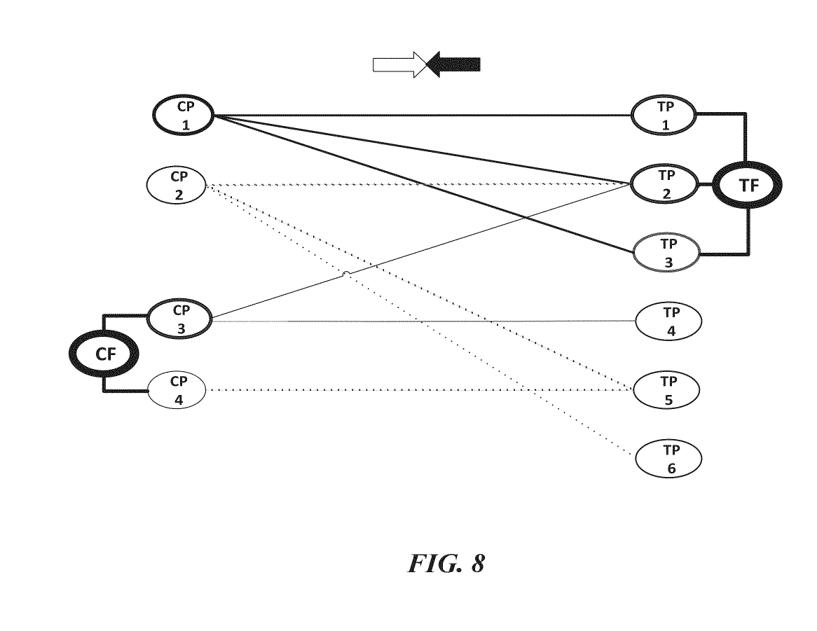

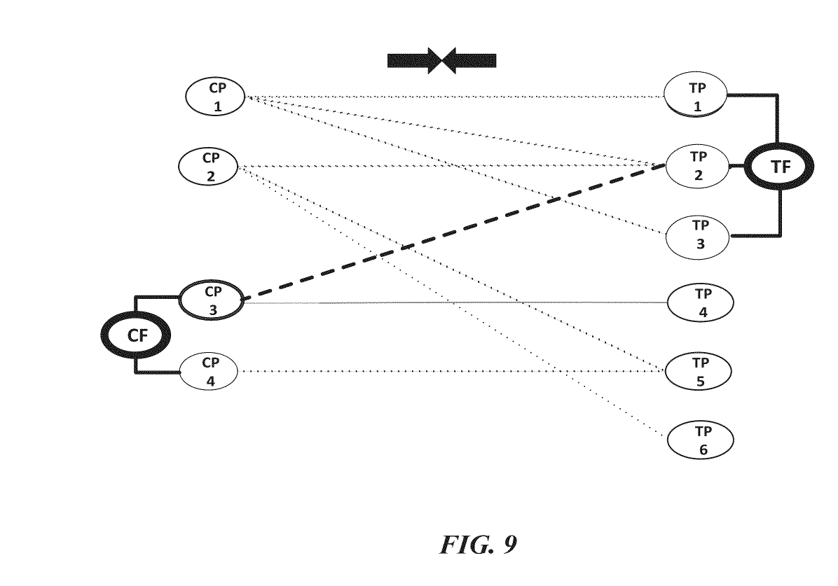

Referring to FIG. 7, an exemplary set of GUI features is provided that may be implemented to allow a user to expand or narrow the TP/CP selection, either based on the concepts disclosed above or independently as a filtering layer as provided in further detail below with reference to FIGS. 8 and 9. As shown in FIG. 7, a filtering mechanism may be utilized to control expansion of candidate groups of TP/CP nodes in different directions. The direction of arrows to the left or right is exemplary in nature. However, by way of example, an arrow pointing away from the center designates and expansion option, and an arrow pointing toward the center designates a narrowing option.

For a more illustrative example, in FIG. 8, the bipartite graph initially shown in FIG. 1A is reproduced with the TP and CP nodes maintaining the same relationships (e.g., as noted by the connecting edges). For example, choosing a clinical feature with the value “metastatic” may filter the choices and result in selection of CP3 and CP4 from the CP list. In the state illustrated in FIG. 8, a filtering mechanism may be used to select CP3 and CP4 on the left and TP1, TP2, TP3 on the right. For example, the CF filter may result in selection of CP3 and CP4 that have a common attribute (e.g., CP3=metastasized type 1, CP4=metastasized type 2, where the common attribute is “metastasized”). Similarly, the TF filter may result in selection of TP1, TP2, TP3 (e.g., TP1=Surgery type 1, TP2=Surgery type 2, and TP3 =Surgery type 3, where the common attribute is “surgery”).

In the example of FIG. 8, the user has interacted with the GUI (e.g. a represent by the arrows on the top of the figure) to narrow the candidate CPs (e.g., limit the candidate group to the left side of the graph). As shown by the edges with solid lines, in this scenario, CP1 and CP3 are the candidate nodes based on this narrowing option—the edges with dotted lines represent the relationship between the other TP/CP pairs, which due to the narrowing option shown in FIG. 8 are no longer in the candidate state.

In the example of FIG. 9, a next optional step is taken, where the user has, for example, further interacted with the GUI to also narrow the candidate TPs (e.g., limit the candidate groups on both sides of the graph). The result of this narrowing step is illustrated by the edge with the dashed line connecting the candidate nodes CP3 and TP2 according to this filtering option. For the purpose of brevity, not all possible filtering scenarios are discussed for this expansion/narrowing feature. However, it should be appreciated that the above features or equivalents thereof may be used to further filter the candidate groups in different directions as desired.

It is noteworthy that the illustrative examples provided above, along with the supporting figures, are introduced as possible implementations with respect to TP/CP nodes presented in a bipartite graph. Depending on implementation, other data structures or database methodologies may be used to achieve the same. Furthermore, the manner in which certain example GUI features are implemented to help a user determine the relationships between TP/CP pairs may vary depending on technical or structural applications and design choices available over a software or hardware-based platform.

In conclusion, in view of the above disclosed concepts and implementations, the most suitable TP/CP pairs may be presented to a user by way of the user interacting with different filtering means or selection features. As discussed, the correlation between the TP/CP pairs may be determined according to information included in a guideline or recommendation database, collections of data achieved from patient records or other resources. In one embodiment, more specific choices may be presented to a user, desirably using an algorithm, taking into account the number of times that the TP/CP pair has been used (e.g., the number of patients on which the TP has been used to treat the same or similar CP).

References in this specification to “an embodiment”, “one embodiment”, “one or more embodiments” or the like, mean that the particular element, feature, structure or characteristic being described is included in at least one embodiment of the disclosed subject matter. Occurrences of such phrases in this specification should not be particularly construed as referring to the same embodiment, nor should such phrases be interpreted as referring to embodiments that are mutually exclusive with respect to the discussed features or elements.

In different embodiments, the claimed subject matter may be implemented as a combination of both hardware and software elements, or alternatively either entirely in the form of hardware or entirely in the form of software. Further, computing systems and program software disclosed herein may comprise a controlled computing environment that may be presented in terms of hardware components or logic code executed to perform methods and processes that achieve the results contemplated herein. Said methods and processes, when performed by a general purpose computing system or machine, convert the general purpose machine to a specific purpose machine.

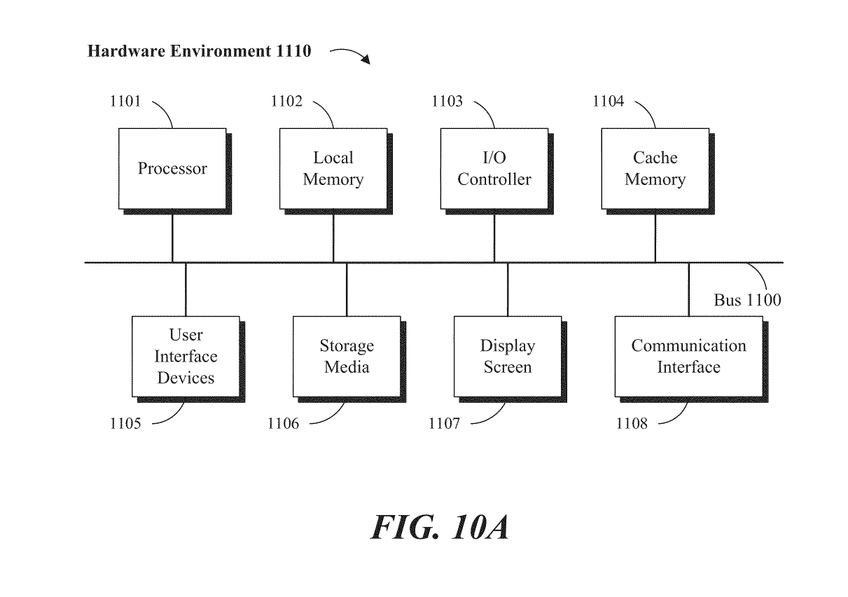

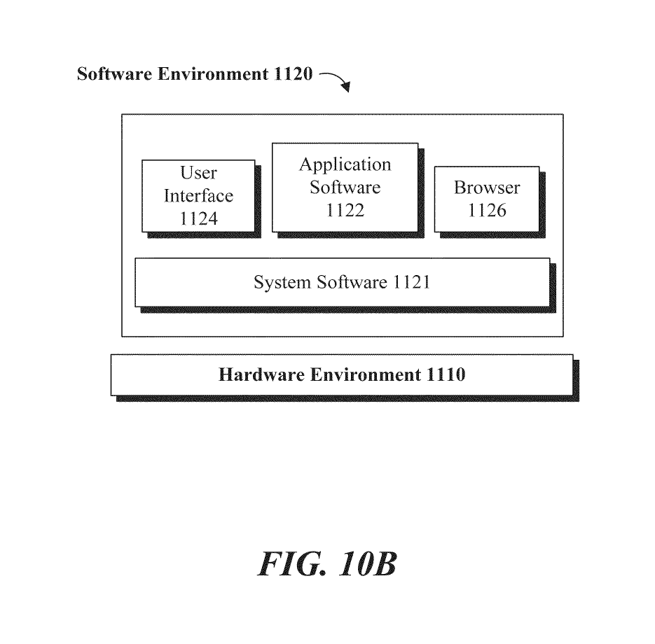

Referring to FIGS. 10A and 10B, a computing system environment in accordance with an exemplary embodiment may be composed of a hardware environment 1110 and a software environment 1120. The hardware environment 1110 may comprise logic units, circuits or other machinery and equipments that provide an execution environment for the components of software environment 1120. In turn, the software environment 1120 may provide the execution instructions, including the underlying operational settings and configurations, for the various components of hardware environment 1110.

Referring to FIG. 10A, the application software and logic code disclosed herein may be implemented in the form of machine readable code executed over one or more computing systems represented by the exemplary hardware environment 1110. As illustrated, hardware environment 110 may comprise a processor 1101 coupled to one or more storage elements by way of a system bus 1100. The storage elements, for example, may comprise local memory 1102, storage media 1106, cache memory 1104 or other machine-usable or computer readable media. Within the context of this disclosure, a machine usable or computer readable storage medium may include any recordable article that may be utilized to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-R/W), digital video disk (DVD), high definition video disk (HD-DVD) or Blue-ray™ disk.

In one embodiment, processor 1101 loads executable code from storage media 1106 to local memory 1102. Cache memory 1104 optimizes processing time by providing temporary storage that helps reduce the number of times code is loaded for execution. One or more user interface devices 1105 (e.g., keyboard, pointing device, etc.) and a display screen 1107 may be coupled to the other elements in the hardware environment 1110 either directly or through an intervening I/O controller 1103, for example. A communication interface unit 1108, such as a network adapter, may be provided to enable the hardware environment 1110 to communicate with local or remotely located computing systems, printers and storage devices via intervening private or public networks (e.g., the Internet). Wired or wireless modems and Ethernet cards are a few of the exemplary types of network adapters.

It is noteworthy that hardware environment 1110, in certain implementations, may not include some or all the above components, or may comprise additional components to provide supplemental functionality or utility. Depending on the contemplated use and configuration, hardware environment 1110 may be a machine such as a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, communication interface 1108 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

Referring to FIG. 10B, software environment 1120 may be generally divided into two classes comprising system software 1121 and application software 1122 as executed on one or more hardware environments 1110. In one embodiment, the methods and processes disclosed here may be implemented as system software 1121, application software 1122, or a combination thereof. System software 1121 may comprise control programs, such as an operating system (OS) or an information management system, that instruct one or more processors 1101 (e.g., microcontrollers) in the hardware environment 1110 on how to function and process information. Application software 1122 may comprise but is not limited to program code, data structures, firmware, resident software, microcode or any other form of information or routine that may be read, analyzed or executed by a processor 1101.

In other words, application software 1122 may be implemented as program code embedded in a computer program product in form of a machine-usable or computer readable storage medium that provides program code for use by, or in connection with, a machine, a computer or any instruction execution system. Moreover, application software 1122 may comprise one or more computer programs that are executed on top of system software 1121 after being loaded from storage media 1106 into local memory 1102. In a client-server architecture, application software 1122 may comprise client software and server software. For example, in one embodiment, client software may be executed on a client computing system that is distinct and separable from a server computing system on which server software is executed.

Software environment 1120 may also comprise browser software 1126 for accessing data available over local or remote computing networks. Further, software environment 1120 may comprise a user interface 1124 (e.g., a graphical user interface (GUI)) for receiving user commands and data. It is worthy to repeat that the hardware and software architectures and environments described above are for purposes of example. As such, one or more embodiments may be implemented over any type of system architecture, functional or logical platform or processing environment.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams, can be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur in any order or out of the order noted in the figures.

For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, may be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A computer implemented method comprising:
providing a graphical user interface (GUI) to facilitate selection of one or more treatment plans (TPs) for one or more clinical presentations (CPs),
wherein data records for the TPs and the CPs are implemented over a data structure that defines one or more relationship between the CPs and the TPs, according to medical guidelines or clinical data;
wherein interaction with the GUI allows for filtering through TPs associated with one or more CPs, or filtering through CPs associated with one or more TPs,
wherein interaction with the GUI allows for filtering through TFs associated with one or more TPs which in turn are associated with one or more CPs, or filtering through CFs associated with one or more CPs which in turn are associated with one or more TPs,
wherein selecting a CP from among a plurality of the CPs results in display of one or more TPs associated with the selected CP,
wherein selecting a TP from among the one or more TPs associated with the selected CP results in display of one or more CPs associated with the selected TP, without requiring a reverse diagnosis to be determined for the selected TP, and
wherein cross-referencing between results displayed in response to the selection of the selected CP and TP provides details that help determine one or more relevant TPs for a target CP, whether or not the relevant TPs have been recommended under the medical guidelines.

2. The method of claim 1, wherein the GUI provides a CP chart including a list of one or more CPs, and a TP chart including a list of one or more TPs associated with the one or more CPs in the CP chart.

3. The method of claim 2, wherein the list of TPs in the TP chart is generated in response to user interaction with the GUI to filter through a plurality of CPs recorded in a database in association with the TPs shown in the TP chart.

4. The method of claim 3, wherein the list of CPs in the CP chart is generated in response to user interaction with the GUI to filter through a plurality of TPs recorded in a database in association with the CPs shown in the CP chart.

5. The method of claim 1, wherein selecting a CP from the CP chart narrows or expands the list of TPs shown in the TP chart to TPs associated with said CP.

6. The method of claim 1, wherein selecting a TP from the TP chart narrows or expands the list of CPs shown in the CP chart to CPs associated with said CP.

7. The method of claim 1, wherein the GUI is implemented to indicate whether a TP associated with a CP is a recommended TP for that CP according to the medical guidelines.

8. The method of claim 1, wherein the GUI is implemented to indicate whether a TP associated with a CP is a deviation TP for that CP according to the clinical data.

9. The method of claim 1, wherein the clinical data includes patient treatment history records.

10. The method of claim 1, wherein the data structure is a bipartite graph, where the TPs are represented by a first series of nodes and the CPs are represented by a second series of nodes, wherein one or more relationships are defined between the nodes in the first series of nodes and the second series of nodes.

11. The method of claim 1, wherein the TPs and the CPs are associated with a plurality of states.

12. The method of claim 11, wherein the plurality of states comprise a neutral state, a candidate state and a selected state.

13. The method of claim 12, wherein the state associated with a TP or a CP is updated based on user interaction with the GUI.

14. The method of claim 13, wherein the GUI comprises an edge indicator that is calculated according to the relationship between a state of a CP in association with a state of a corresponding TP.

15. The method of claim 14, wherein the edge indicator is calculated as the number of incoming edges to a node representing a TP or a CP from a given group of TPs or CPs out of the number of the outgoing edges from the relevant group.

16. The method of claim 14, wherein an edge indicator is associated with one or more nodes provides that a certain percentage of the patient population with the same CP got the indicated TP.

17. The method of claim 10, wherein a user may interact with the GUI to expand or narrow groups of TPs or CPs in the bipartite graph that are in a candidate state according to an applied filtering option.

18. A computer implemented system comprising:
one or more processors;
a logic unit for providing a graphical user interface (GUI) to facilitate selection of one or more treatment plans (TPs) for one or more clinical presentations (CPs),
wherein data records for the TPs and the CPs are implemented over a data structure that defines one or more relationship between the CPs and the TPs, according to medical guidelines or clinical data;
wherein interaction with the GUI allows for filtering through TPs associated with one or more CPs, or filtering through CPs associated with one or more TPs,
wherein interaction with the GUI allows for filtering through TFs associated with one or more TPs which in turn are associated with one or more CPs, or filtering through CFs associated with one or more CPs which in turn are associated with one or more TPs,
wherein selecting a CP from among a plurality of the CPs results in display of one or more TPs associated with the selected CP,
wherein selecting a TP from among the one or more TPs associated with the selected CP results in display of one or more CPs associated with the selected TP, without requiring a reverse diagnosis to be determined for the selected TP, and
wherein cross-referencing between results displayed in response to the selection of the selected CP and TP provides details that help determine one or more relevant TPs for a target CP, whether or not the relevant TPs have been recommended under the medical guidelines.

19. The system of claim 18, wherein the GUI provides a CP chart including a list of one or more CPs, and a TP chart including a list of one or more TPs associated with the one or more CPs in the CP chart.

20. A computer program product comprising a non-transitory data storage medium having a computer readable program, wherein the computer readable program when executed on a computer causes the computer to:
provide a graphical user interface (GUI) to facilitate selection of one or more treatment plans (TPs) for one or more clinical presentations (CPs),
wherein data records for the TPs and the CPs are implemented over a data structure that defines one or more relationship between the CPs and the TPs, according to medical guidelines or clinical data;
wherein interaction with the GUI allows for filtering through TPs associated with one or more CPs, or filtering through CPs associated with one or more TPs,
wherein interaction with the GUI allows for filtering through TFs associated with one or more TPs which in turn are associated with one or more CPs, or filtering through CFs associated with one or more CPs which in turn are associated with one or more TPs,
wherein selecting a CP from among a plurality of the CPs results in display of one or more TPs associated with the selected CP,
wherein selecting a TP from among the one or more TPs associated with the selected CP results in display of one or more CPs associated with the selected TP, without requiring a reverse diagnosis to be determined for the selected TP, and
wherein cross-referencing between results displayed in response to the selection of the selected CP and TP provides details that help determine one or more relevant TPs for a target CP, whether or not the relevant TPs have been recommended under the medical guidelines.
